(19) United States
(12) Patent Application Publication
(10) Pub. No.: US 2021/0206109 A1
(43) Pub. Date: Jul. 8, 2021

(54) 3D PRINTER PLATFORM POSITIONER

(71) Applicant: HEWLETT-PACKARD DEVELOPMENT COMPANY, L.P., Spring, TX (US)

(72) Inventors: Michael EWE, Vancouver, WA (US); Eric COLLINS, Vancouver, WA (US); Wesley R. SCHALK, Vancouver, WA (US)

(73) Assignee: HEWLETT-PACKARD DEVELOPMENT COMPANY, L.P., Houston, TX (US)

(21) Appl. No.: 16/075,437

(22) PCT Filed: Apr. 17, 2017
(86) PCT No.: PCT/US2017/027980

§ 371 Date: Aug. 3, 2018

(51) Int. Cl. B29C 64/393; B29C 64/245; B29C 64/232; B33Y 30/00; B33Y 50/02

(52) U.S. Cl. CPC B29C 64/393; B29C 64/245; B29C 64/153; B33Y 30/00; B33Y 50/02; B29C 64/232

(57) ABSTRACT

A 3D printer includes a movable platform, a motor to vertically translate the movable platform during an additive manufacturing process executed by the 3D printer to form a product on the movable platform, a linear encoder strip attached to the movable platform and a linear encoder reader disposed to read the linear encoder strip as the linear encoder strip moves relative to the linear encoder reader. A control circuit is to drive the motor based on an output of the linear encoder reader.

### BACKGROUND

Some 3D printers may include a movable platform on which successive layers of a 3D print material (e.g., a nylon powder, a metal powder, etc.), are applied, spread and fused or bonded, layer-by-layer, to build a product. In a powder bed fusion process, a 3D material applicator applies a layer of the 3D print material in a predetermined thickness across a work area or build area of the movable platform. A 3D print material bonding device then selectively applies energy to the layer of the 3D print material to fuse or bond selected portions of the layer of the 3D print material corresponding to a cross-section of the desired product at the vertical position of the layer. This process continues, layer-by-layer, until the entire product is built from the assembled layers. 3D print material that is not fused or bonded in the product build is removed in post processing.

The lowering of the movable platform is performed with high precision to provide consistent 3D print material thickness and uniformity. To achieve a high level of precision, the movable platform may be controlled via a rotary encoder system attached to the motor or other intermediate drive shaft with a high gear reduction to enhance encoder resolution.

### BRIEF DESCRIPTION OF THE DRAWINGS

FIG. 1 depicts movement over time of an example 3D printer platform by a 3D printer platform positioner using a rotary encoder system.

FIG. 2 depicts movement over time of an example 3D printer platform by a 3D printer platform positioner constructed in accordance with teachings of this disclosure.

FIG. 3 is a block diagram of an example 3D printer, constructed in accordance with teachings of this disclosure, with an example 3D printer platform in a first position.

FIG. 4 is a block diagram of the example 3D printer of FIG. 3, with the example 3D printer platform in a second position.

FIG. 5 is a block diagram of an example print manager for the example 3D printer of FIGS. 3-4 constructed in accordance with teachings of this disclosure.

FIG. 6 is a flowchart representative of example machine readable instructions which may be executed to implement the example print manager of FIG. 5 and/or the example 3D printer of FIGS. 3-4 in accordance with teachings of this disclosure.

FIG. 7 is a block diagram of an example processor platform which may execute the example instructions of FIG. 6 to implement the example print manager of FIG. 5 and/or the example 3D printer of FIGS. 3-4 in accordance with teachings of this disclosure.

The figures are not to scale. Instead, to clarify multiple layers and regions, the thickness of the layers may be enlarged in the drawings. Wherever possible, the same reference numbers will be used throughout the drawing(s) and accompanying written description to refer to the same or like parts. As used in this patent, stating that any part (e.g., a layer, film, area, or plate) is in any way positioned on (e.g., positioned on, located on, disposed on, or formed on, etc.) another part, means that the referenced part is either in contact with the other part, or that the referenced part is above the other part with one or more intermediate part(s) located therebetween. Stating that any part is in contact with another part means that there is no intermediate part between the two parts.

### DETAILED DESCRIPTION

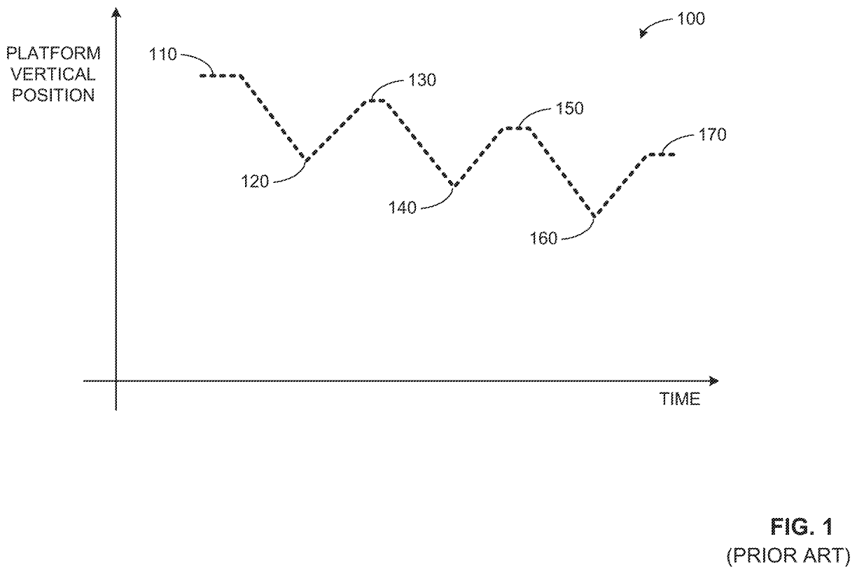

FIG. 1 shows an example of a movable platform positioning system controlled via a rotary encoder system, with a plot 100 of the movable platform vertical position (Z-axis) versus time. At a first target position 110, a first layer of 3D print material is applied and processed. The movable platform is then moved downwardly to a point 120 below that of a second target position 130 to account for gear backlash, runout, mechanical compliance, or other mechanical variability and is then moved upwardly to the second target position 130. At the second target position 130, a second layer of 3D print material is applied and processed. The movable platform is then moved downwardly to a point 140 below that of a third target position 150 to account for gear backlash, runout, mechanical compliance, or other mechanical variability and is then moved upwardly to the third target position 150. At the third target position 150, a third layer of 3D print material is applied and processed. The movable platform is then moved downwardly to a point 160 below that of a fourth target position 170 and is then moved upwardly to the fourth target position 170. At the fourth target position 170, a fourth layer of 3D print material is applied and processed.

Contrary to the movable platform control systems explained above in relation to FIG. 1, the example movable platform control systems herein use a linear encoder system to encode the actual axis of motion of the movable platform. For instance, in some examples of movable platform control systems herein, a linear encoder strip is attached to the movable platform and a corresponding encoder reader is in a fixed position relative to the 3D printer housing. In some examples, a linear encoder strip is in a fixed position relative to the 3D printer housing and a corresponding encoder reader is attached to the movable platform, the encoder reader being communicatively attached to the 3D printer via a moving electrical flex cable (FFC) which powers the encoder reader. These implementations of a movable platform positioner enables direct positioning of the movable platform, with indexing in the same direction during movement, avoids the marked reversals of movement of the movable platform that occur with the movable platform control systems using a rotary encoder system, which can result in process delay, powder compaction and poor bed quality. The disclosed direct positioning of the movable platform also avoids layer to layer thickness variations potentially arising from the mechanical variability (e.g., gear backlash, runout, mechanical compliance, etc.) of the movable platform control systems using a rotary encoder system.

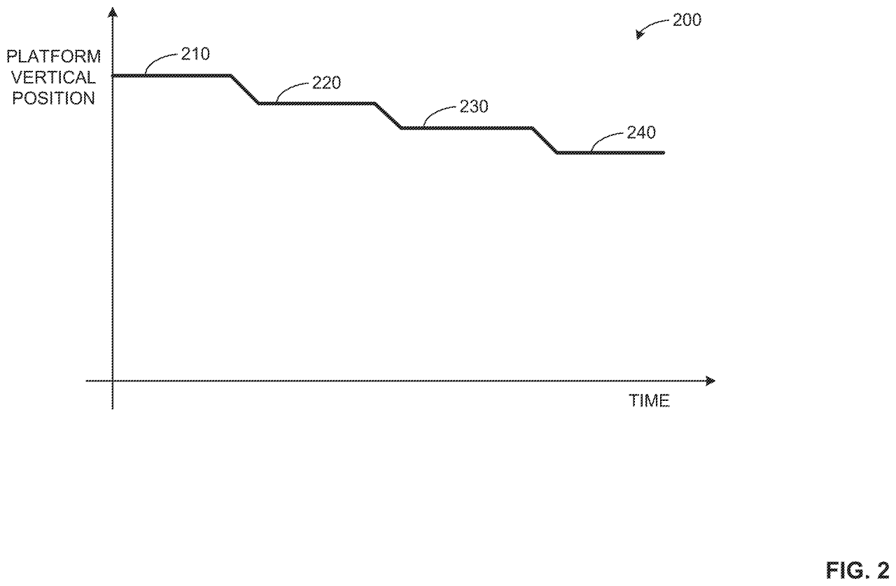

FIG. 2 shows a plot 200 of vertical position (Z-axis) of an example movable platform of an example 3D printer platform, controlled by an example movable platform positioner (described below) versus time. At a first target position 210, a first layer of 3D print material is applied and processed. The movable platform is then moved in a first direction (e.g., downwardly) to a second target position 220, where a second layer of 3D print material is applied and processed. The movable platform is then moved in the first direction to a third target position 230, where a third layer of 3D print material is applied and processed. The movable platform is then moved in the first direction to a fourth target position 240, where a fourth layer of 3D print material is applied and processed. A target thickness of a layer of 3D print material may range from 60 to 100 microns and, to enable good layer to layer uniformity, an accuracy of the movable platform position should be within about 20% of the target thickness (e.g., within about 12 microns).

The example 3D printer platform positioner including an example linear encoder strip attached to the movable platform and a corresponding encoder reader attached to a 3D printer housing, or other stationary structure, minimizes movement of the movable platform, thus minimizing disturbance to the powder and workpiece borne by the movable platform. This helps to avoid powder movement, such as compaction or displacement, and workpiece movement.

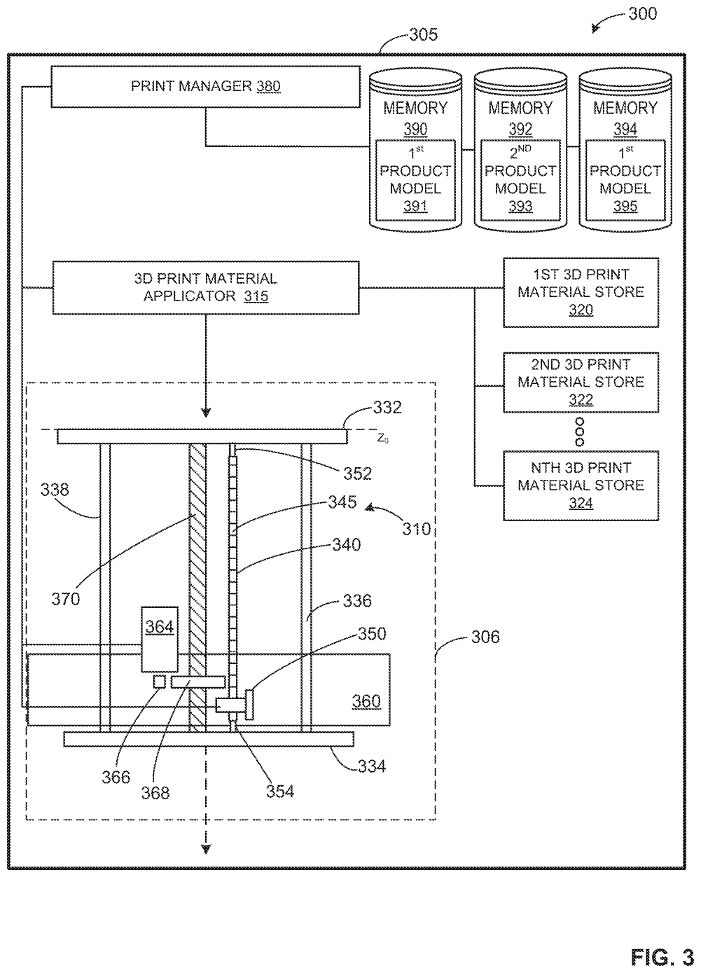

FIG. 3 is a block diagram of an example 3D printer 300 including an example housing 305 and an example build unit 306 for the example 3D printer 300. The example build unit 306 includes an example movable platform 310 positioned at an initial vertical position (Z₀) and an example 3D print material applicator 315. As shown in FIG. 3, the example movable platform 310 is disposed in a first position beneath the 3D print material applicator 315 to apply 3D print material (e.g., a nylon powder, a glass-filled nylon powder, an aluminum-filled nylon powder, an acrylonitrile butadiene styrene (ABS) powder, a polymethyl methacrylate powder, a stainless steel powder, a titanium powder, an aluminum powder, a cobalt chrome powder, a steel powder, a copper powder, and/or a composite powder having a plurality of materials, etc.). In some examples, the 3D print material may include coatings (e.g., titanium dioxide) or fillers to alter one or more characteristics and/or behaviors of the 3D print material (e.g., coefficient of friction, selectivity, melt viscosity, melting point, powder flow, moisture absorption, etc.).

The example 3D print material applicator 315 receives one or more 3D print materials from an example first 3D print material store 320, an example second 3D print material store 322, and an example N^{th} 3D print material store 324, where N represents any integer. In some examples, two or more of the example first 3D print material store 320, the example second 3D print material store 322 and/or the example N^{th} 3D print material store 324 include a different 3D print material. In some examples, any of the example first 3D print material store 320, the example second 3D print material store 322 and/or the example N^{th} 3D print material store 324 may include fresh material or recycled material. In some examples, the example 3D print material applicator 315 is to dispense the 3D material at selected voxels, or points in space, relative to an upper surface of the example movable platform 310 or relative to an upper surface or build surface of a workpiece on the upper surface of the movable platform 310. In some examples, the 3D print material applicator 315 does not itself directly deposit materials onto the example movable platform 310, but rather uses an example depositor to deposit a layer of print material adjacent the example movable platform 310 and then uses an example spreader to uniformly spread the layer of print material across the example movable platform 310, where it may then be selectively fused (e.g., stereolithography, selective laser sintering, selective laser melting, selective heat sintering, etc.) by an example fuser.

The example movable platform 310 includes an example upper platform 332 forming a working area upon which a workpiece may be formed, an example lower platform 334, and a plurality of example platform travel guides 336, 338 connecting the example upper platform 332 and the example lower platform 334. An example linear encoder strip 340 is attached to the example movable platform 310. The example linear encoder strip 340 includes features 345 (e.g., lines, grooves, marks, etc.), spaced apart by a predetermined distance, that may be sensed by an example encoder reader 350 attached to an example bracket 360, the example housing 305, or another stationary component. In some examples, the features 345 are spaced apart by about 0.0050″ to provide 200 features 345 (e.g., lines, slots, etc.) per inch.

In some examples, the example linear encoder strip 340 is a plastic strip with features 345 printed or provided thereon. In some examples, the example linear encoder strip 340 includes a transparent plastic strip having features 345 printed or formed on a front side or a back side of the transparent plastic strip. In some examples, the example linear encoder strip 340 is an opaque plastic strip having features 345 printed or formed on a front side of the opaque plastic strip, with the features 345 facing the example encoder reader 350. In some examples, the linear encoder strip 340 is a metal strip (e.g., aluminum, stainless steel, etc.) with features 345 (e.g., slots, marks, etc.) formed on a front side to face the example encoder reader 350. In some examples, example linear encoder strip 340 is a magnetic encoder strip.

For 3D printers, powder dust generation causes fine particles of powder to migrate to different areas of the 3D printer, which may accumulate on the example linear encoder strip 340. This may cause a corresponding attenuation of the light from an LED of the example encoder reader 350 and lead position feedback errors and positioning errors. In some examples, this potential error is mitigated by calibrating the example encoder reader 350 to adjust an intensity of an incident light from the example encoder reader 350 upon the example linear encoder strip 340 to compensate for a loss of signal strength attributable to accumulated powder on the example linear encoder strip 340. In some examples, a metal example linear encoder strip 340 having notches as example features 345 inhibits powder accumulation.

In some examples, the example 3D printer 300 includes one or more devices to clean potential powder contamination from the example linear encoder strip 340 and/or other components (e.g., encoder reader 350, etc.). For instance, the example 3D printer 300 includes a nozzle directing compressed air toward the example linear encoder strip 340 or a vacuum element, a brush, a sponge element and/or a wiper that removes powder contamination during movement of the linear encoder strip 340. In some examples, the example linear encoder strip 340 and the example encoder reader 350 form a part of a sealed system to protect these components from powder contamination.

In the example shown, the linear encoder strip 340 is disposed in a central portion of the example movable platform 310, near the drive axis, to minimize potential encoder errors associated with platform tilt during motion. In other examples, the linear encoder strip 340 is disposed in an area of the example movable platform 310 other than in the central portion of the example movable platform 310, with an accounting for potential encoding errors associated with platform tilt during motion for the selected location of the linear encoder strip 340.

In the example of FIG. 3, the linear encoder strip 340 is tensioned with resilient elements 352, 354, such as springs, to maintain the linear encoder strip 340 under tension through movement of the example movable platform 310 and through environmental conditions of the example movable platform 310 (e.g., temperature changes, etc.). In other examples, the linear encoder strip 340 is fixed to the example upper platform 332 or the example lower platform 334 with one or more mechanical fasteners (e.g., screws, bolts, etc.) and is movably connected to the other one of the example upper platform 332 or the example lower platform 334 via one or more connectors (e.g., pin, roller, guide, etc.).

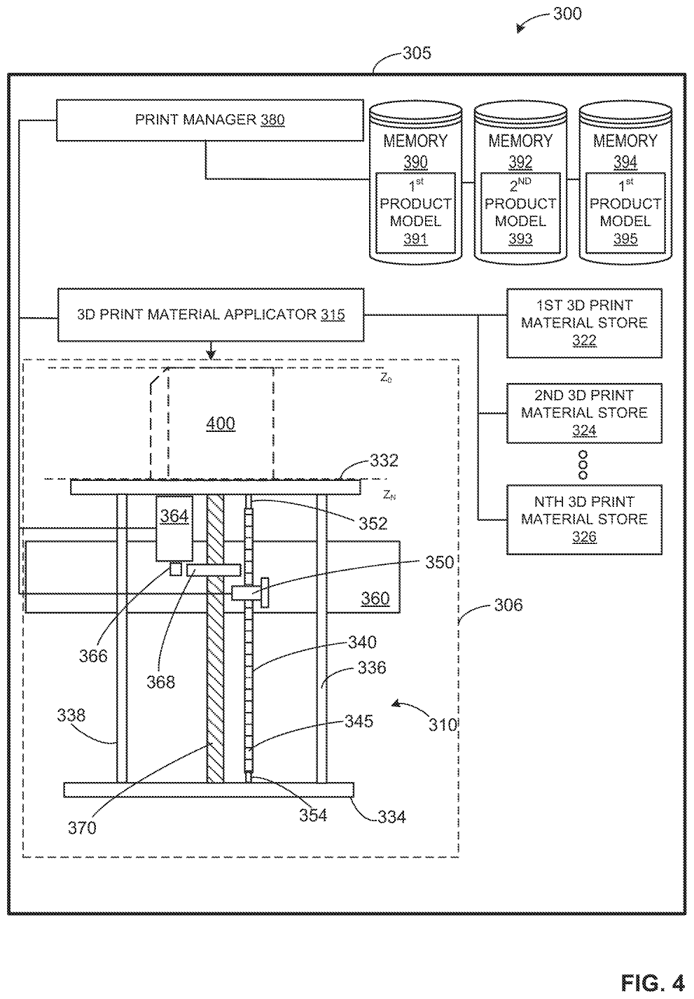

The example encoder reader 350 is fixed to the example housing 305, a stationary component attached to the example housing 305 or, as shown in FIGS. 3-4, the example bracket 360 attached to the example housing 305. Bushings or guides are attached to the example bracket 360, the example housing 305, or another stationary component attached to the example housing 305 to retain and guide the example platform travel guides 336, 338 to stabilize the example movable platform 310. An example motor 364, an example pinion 366 and an example gear 368 used to drive the example lead screw 370, or the like, are attached to the example housing 305, the example bracket 360 and/or another stationary component attached to the example housing 305. The example motor 364 is to vertically translate the movable platform, via the example pinion 366, the example gear 368, and the example lead screw 370, during an additive manufacturing process (e.g., layer-by-layer formation) executed by the example 3D printer 300 to form a product on the example movable platform 310. In some examples, the example motor 364 includes a brushed DC motor having a total gear ratio of 24.5 to 1. In other examples, the example motor 364 may include a servo motor or a stepper motor. In some examples, the example motor 364 includes a brushless DC motor.

In some examples, the example encoder reader 350 is a high-resolution analog sensor or a high resolution digital quadrature encoder to measure motion of the movable platform 310, the direction of motion of the movable platform 310, and the position of the movable platform 310. The example encoder reader 350 provides, as an output, electrical signals translatable into an indication of motion, direction, or position. In some examples, the example encoder reader 350 is a 2 channel, 200 lines per inch (LPI), 3.3V_{CC} (voltage at the common collector) analog encoder reader manufactured by Kodenchi Corp of Japan or Vishay Intertechnology, Inc. of Malvern, Pa.

The analog example encoder reader 350 uses a first sensor for a first channel and a second sensor for a second channel, the second channel being 90° out of phase with respect to the first channel. The phase difference between the first channel and the second channel provides an indication as to a direction of travel. For instance, if the first channel leads the second channel, movement of the example movable platform 310 is in a first direction and if the second channel leads the first channel, movement of the example movable platform 310 is in a second direction. Monitoring the number of pulses from each of the first channel and the second channel of the analog example encoder reader 350, and the relative phases of the channels, permits determination of the position of the example movable platform 310 and the direction of travel.

The example analog example encoder reader 350 enhances the resolution, beyond that of the spacing of the example features 345, by using an analog to digital (A2D) converter to interpolate the position between such features 345. For instance, where the example linear encoder strip 340 having features 345 (e.g., lines) spaced apart by about 0.0050″ to provide 200 lines per inch (LPI), the example analog example encoder reader 350 is able to provide a resolution greater than 0.0050.″ Instead of the traditional square wave output of a digital encoder, the example analog example encoder reader 350 produces out of phase oscillating waveforms (e.g., sine waves and/or cosine waves). The example print manager 380 can interpolate a position of the example movable platform 310 to a position between adjacent features 345, via the A2D converter, using the crossing points of the oscillating waveforms and the detected analog level of the example analog example encoder reader 350 with respect to the crossing points. For instance, the interpolation enables enhancement of resolution, via an example 7-bit A/D (analog to digital) signal conversion, to a final resolution of 200 LPI*4 (quadrature)*7 (bits interpolation)=102,400 encoder counts/inch (CPI) or approximately 4 encoder counts/micron (CPM). This permits the example print manager 380 to position the example movable platform 310 with an accuracy of about 2.5 microns (0.000098″) via the example motor 364, the example pinion 366, the example gear 368, and the example lead screw 370.

As noted above, a typical layer thickness for 3D powder based printers is about 60-100 microns and, to achieve good layer uniformity the layer-to-layer thickness variation should be less than about 20% or, at most, between about 12 to 20 microns. If 20 microns is used as the acceptable limit for accuracy of positioning of (e.g., stopping) the example movable platform 310, the threshold minimum acceptable resolution for the example encoder reader 350 is about 1270 encoder counts per inch (CPI). In one example, such threshold minimum acceptable resolution provides, for an example feature 345 spacing of 300 LPI, a resolution of 1200 CPI.

In the example of FIGS. 3-4, an example print manager 380 communicates with an example memory 390 including instructions for a first product model 391, an example memory 392 including instructions for a second product model 393, and an example memory 394 including instructions for an N^{th} product model 395, where N is any integer. In some examples, the first product model 391, the second product model 393 and the Nth product model 395 include instructions in a 3D printing file format such as, but not limited to, the 3D Manufacturing Format (3MF) Specification and Reference Guide, Ver. 1.1 (2015), including all model, material and property information necessary to form the desired product using the example 3D printer 300.

In some examples, the example build unit 306 is removable from the example 3D printer 300 and includes the example movable platform 310. In some examples, the example build unit 306 includes the example print manager 380. In some examples, the example build unit 306 includes the example encoder reader 350. In some examples, the example build unit 306 includes the example motor 364, the example pinion 366 and the example gear 368. In some examples, the example 3D printer build unit 306 includes the example movable platform 310, the example motor 364 to vertically translate the example movable platform 310 during an additive manufacturing process executed by the example 3D printer 300 to form a product on the example movable platform 310, the example linear encoder strip 340, the example linear encoder reader 350 disposed to read the example linear encoder strip 340 as the example linear encoder strip 340 moves relative to the example linear encoder reader 350 and/or the example control circuit to drive the example motor 364 based on an output of the example linear encoder reader 364. For instance, in some examples, example control circuit to drive the example motor 364 based on an output of the example linear encoder reader 364 is separate from the example build unit 306. In some examples, the example build unit 306 is an integral part of the example 3D printer 300.

FIG. 4 is a block diagram of the example 3D printer 300 of FIG. 3 showing the example movable platform 310 positioned at an example final vertical position (ZN), where N represents a random integer, following iterative application of layers of one or more 3D print materials via the 3D print material applicator and indexing of the example movable platform 310 to yield an example workpiece 400.

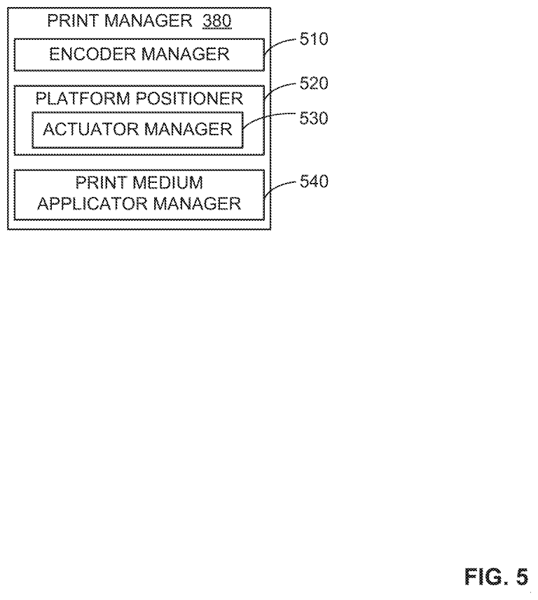

FIG. 5 is a block diagram of the example print manager 380 constructed in accordance with teachings of this disclosure to be used with the example 3D printer 300 depicted in FIGS. 3-4. The example print manager 380 may be implemented by, for example, software existing on a processor within, for instance, the example 3D printer 300 or, alternatively, external to the example 3D printer 300. For example, the example print manager 380 may be implemented by software executed by a server or other computing device located within the restricted area and/or at a remote facility. In this example, the example print manager 380 includes an example encoder manager 510, an example platform positioner 520 including an example actuator manager 530 and an example 3D print material applicator manager 540. The example print manager 380 communicates with the example 3D print material applicator 315, the example motor 364 and the example analog example encoder reader 350 via a hardwired and/or wireless connection.

The example encoder manager 510 receives output signals from the example encoder reader 350 and, using the predetermined relation between the example features 345 of the linear encoder strip 340 (e.g., a spacing, etc.) and the predetermined relation in phase between the first channel and the second channel of the example analog example encoder reader 350, determines a direction of movement, and a degree of movement, of the example movable platform 310 relative to the example encoder reader 350, which is stationary. The example encoder manager 510 determines the position of the example movable platform 310 using pulses from the first channel and the second channel of the analog example encoder reader 350 corresponding to the example features 345 and interpolation of the waveforms of the first channel and the second channel.

The example platform positioner 520, responsive to the movable platform 310 position and direction of movement determined by the example encoder manager 510, controls the example actuator manager 530 to drive the actuator(s) (e.g., the example motor 364) and the example movable platform 310 (e.g., via the example pinion 366, the example gear 368, and the example lead screw 370) at a specified speed in a specified direction, or to stop and hold the actuator(s) at a specified position. In some examples, the example platform positioner 520 controls movement of the example movable platform 310 by using readings from the example linear encoder reader 350 as an input to a closed loop feedback circuit including the example platform positioner 520.

Following positioning of the example movable platform 310 by the example platform positioner 520, the example print medium applicator manager 540 is to cause the 3D print material applicator 315 to apply one or more 3D print materials from one or more of the 1^{st} 3D print material store 320, the 2^{nd} 3D print material store 322, and/or the N^{th} 3D print material store 324, in a predetermined pattern for each layer of a product produced by the example 3D printer 300. The 3D print material may include, for example, a nylon powder, a glass-filled nylon powder, an aluminum-filled nylon powder, an ABS powder, a polymethyl methacrylate powder, a stainless steel powder, a titanium powder, an aluminum powder, a cobalt chrome powder, a steel powder, a copper powder, and/or a composite powder having a plurality of materials.

While an example manner of implementing the example print manager 380 is set forth in FIG. 5, one or more of the elements, processes and/or devices illustrated in FIG. 5 may be combined, divided, re-arranged, omitted, eliminated and/or implemented in any other way. For example, the example print manager 380, the example encoder manager 510, the example platform positioner 520, the example actuator manager 530 and/or the example 3D print material applicator manager 540 of FIG. 5 may be implemented by hardware, software, firmware and/or any combination of hardware, software and/or firmware. Thus, for example, any or all of the example print manager 380, the example encoder manager 510, the example platform positioner 520, the example actuator manager 530 and/or the example 3D print material applicator manager 540 of FIG. 5 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example print manager 380, the example encoder manager 510, the example platform positioner 520, the example actuator manager 530 and/or the example 3D print material applicator manager 540 are hereby expressly defined to include a non-transitory computer-readable storage device or storage disk such as a memory, a digital versatile disk (DVD), a compact disk (CD), a Blu-ray disk, a flash memory, etc. storing the software and/or firmware. Further still, the example print manager 380, the example encoder manager 510, the example platform positioner 520, the example actuator manager 530 and/or the example 3D print material applicator manager 540 of FIG. 5 may include one or more elements, processes and/or devices in addition to, or instead of, those illustrated in FIGS. 3-4, for example, and/or may include more than one of any or all of the illustrated elements, processes and devices.

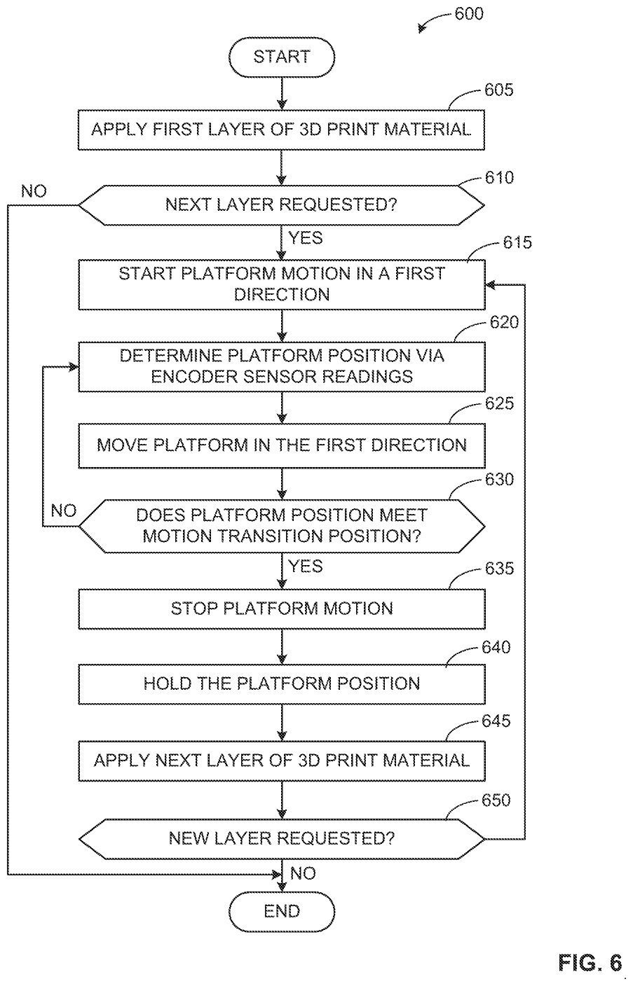

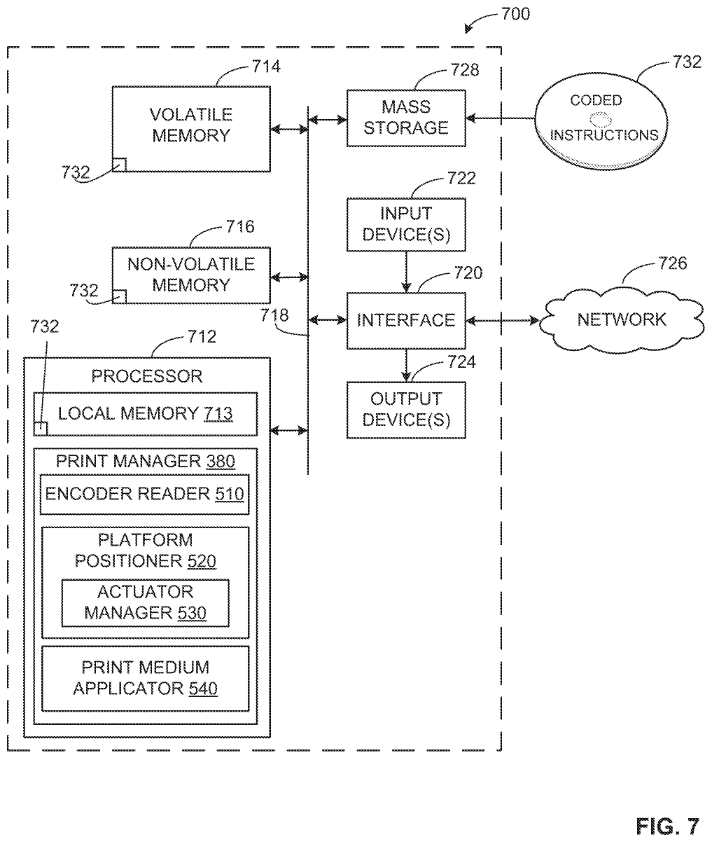

An example flowchart representing example machine readable instructions for implementing example print manager 380 of FIG. 5 is shown in FIG. 6. In the example of FIG. 6, the machine-readable instructions are for execution by one or more processors, such as the example processor platform 700 discussed below in connection with FIG. 7. The program may be embodied in software stored on a non-transitory computer-readable storage medium such as a CD-ROM, a floppy disk, a hard drive, a digital versatile disk (DVD), a Blu-ray disk, a cloud-based server memory, a remote computer memory, or a memory associated with the example processor 712, but the entire program and/or parts thereof could alternatively be executed by a device other than the example processor 712 and/or embodied in firmware or dedicated hardware. Further, although the example program is described with reference to the flowcharts illustrated in FIG. 6, many other methods of implementing the example print manager 380 may alternatively be used. For example, the order of execution of the blocks in FIG. 6 may be changed, and/or some of the blocks described may be changed, eliminated, and/or combined.

As mentioned above, the example machine readable instructions shown in FIG. 6 for implementing the example print manager 380 disclosed herein, may be implemented using coded instructions (e.g., computer and/or machine readable instructions) stored on a non-transitory computer and/or machine readable medium, wherever located, such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used (e.g., as the transition term in a preamble of a claim), it is open-ended in the same manner as the term “comprising” is open ended.

The example program 600 of FIG. 6 begins at block 605 where the example print manager 380 applies a first layer of 3D print material to a working area of the example movable platform 310, held at an initial vertical position Z₀, such as via the example 3D print material applicator 315. Included within block 605 is processing of the applied layer of 3D print material (e.g., application of energy) to effect a state change to the 3D print material (e.g., selective fusing of 3D print material in specified area(s)) to form a first layer of a workpiece corresponding to a pattern for a product produced on the example 3D printer 300. Control passes to block 610.

At block 610, the example print manager 380 determines if a next layer of a 3D print material is to be applied to the workpiece comprising the first layer formed at block 605. If the result at block 610 is “NO,” the example program 600 ends. If the result at block 610 is “YES,” control passes to block 615.

At block 615, the example print manager 380 causes the example platform positioner 520 to index the example movable platform 310 and start downward motion of the example movable platform 310 via the example actuator manager 530. In some examples, the example movable platform 310 is moved downwardly at a single fixed speed. In other examples, the example movable platform 310 is initially moved in a first direction (e.g., downwardly) at a first intermediate speed and is then slowed to a second speed as the movable platform 310 approaches a position at which the next layer of 3D print material is to be applied.

At block 620, during motion of the example movable platform 310 in the first direction, the example encoder manager 510 determines the position of the example movable platform 310 using the output signals (e.g., quadrature modulated signals, etc.) from the example encoder reader 350 responsive to motion of the example features 345 of the example linear encoder strip 340 relative to the example encoder reader 350.

At block 625, concurrent with the determination of the position of the example movable platform 310 by the example encoder reader 350 and the example encoder manager 510 at block 620, the example platform positioner 520 continues to move the example movable platform 310 in the first direction via the example actuator manager 530.

At block 630, concurrent with the determination of the position of the example movable platform 310 by the example encoder reader 350 and the example encoder manager 510 at block 620 and concurrent with the continued movement of the example movable platform 310 by the example platform positioner 520, the example print manager 380 determines whether the movable platform 310 position meets a motion transition position. The motion transition position refers to one or more position thresholds at which the example platform positioner 520 is to initiate a controlled deceleration of the example movable platform 310 from a first velocity to a second velocity, where the second velocity is a non-zero velocity lower than that of the first velocity (i.e., decelerating the example movable platform 310, with the example movable platform 310 continuing movement in the first direction) or is a zero velocity (i.e., decelerating the example movable platform 310 to a stop). In some examples, the second speed of the movable platform 310 is on the order of a few encoder counts per actuator (e.g., example motor 364) interrupt.

In some examples, the example platform positioner 520 moves the example movable platform 310 initially at a first intermediate speed and then at a slower second speed as the movable platform 310 approaches a target position at which the next layer of 3D print material is to be applied. In such example, the motion transition position is a position of the movable platform 310 where the example platform positioner 520 instructs the actuator(s) (e.g., example motor 364) to slow to the movable platform 310 to the second speed. For example, a first transition position is an empirically measured distance it takes to the example movable platform 310 to decelerate to a slow velocity plus a distance buffer to take into account variations and tolerances plus a second transition distance. The second transition distance is an empirically measured distance from a deceleration of the example movable platform 310 to a complete stop. If the example platform positioner 520 is moving the example movable platform 310 at a slowest selected speed (e.g., the initial speed of a constant speed drive, the slower second speed noted above, etc.), the motion transition position is a position of the movable platform 310 where the example platform positioner 520 instructs the actuator(s) (e.g., example motor 364) to bring the example movable platform 310 to a stop and to hold the example movable platform 310 at the position at which it is stopped.

If a motion transition position has been determined not to have been satisfied by the example platform positioner 520 (block 630=“NO”) control returns to block 620. In the example of FIG. 6, if a motion transition position has been determined to have been satisfied by the example platform positioner 520 (block 630=“YES”) control passes to block 635. In other examples, where a plurality of motion transition positions are used to step down a velocity of the example movable platform 310, the loop of example block 620, example block 625, and example block 630 are repeated for each successive motion transition position prior to passing of control to example block 635.

At block 635, following a determination in block 630 that a motion transition position criterion is satisfied, the example platform positioner 520 instructs the actuator(s) (e.g., example motor 364) to stop the example movable platform 310 and, in block 640, to hold the example movable platform 310 in position.

At block 645, the example print manager 380 applies a next layer of 3D print material (e.g., a second layer of 3D print material, etc.) to the working area of the example movable platform 310 (e.g., to the workpiece, etc.), held at an vertical position Z₁, such as via the example 3D print material applicator 315. Included within block 645 is processing of the applied next layer of 3D print material (e.g., application of energy) to effect a state change to the 3D print material (e.g., selective fusing of 3D print material in specified area(s)) to form the next layer of the workpiece (e.g., 400) corresponding to the pattern for the product produced by the example 3D printer 300. Control passes to block 650.

At block 650, the example print manager 380 determines if a next layer of a 3D print material is to be applied to the workpiece formed at block 645. If the result at block 650 is “NO,” the example program 600 ends. If the result at block 650 is “YES,” control passes to block 615.

For example, to illustrate an example implementation of the example program 600 of FIG. 6, thus iteratively applies a layer of a 3D print material via a 3D print material applicator 315 to a movable platform 310 positioned at a first position (e.g., Z₀), moves the movable platform 310 from the first position to a second position by moving the movable platform 310 in a first direction (see, e.g., FIG. 2), applies a layer of the 3D print material, or of another of 3D print material, via the 3D print material applicator 315 to the movable platform 310 positioned at a second position (e.g., Z₁) and moves the movable platform 310 from the second position to a third position (e.g., Z₂) by moving the movable platform 310 in the first direction (see, e.g., FIG. 2). In each iteration of movement in the first direction, the example platform positioner 520 moves the example movable platform 310 to a target position (e.g., Z₃) with an accuracy of about 2.5 microns, which ensures that even if an overshoot were to occur, the potential overshoot would be limited to a small fraction (less than about 4%) of a thickness of a layer (e.g., about 60-100 microns), obviating a need for positional correction.

As noted above, FIG. 7 is a block diagram of an example processor platform 700 capable of executing the example instructions of FIG. 6 to implement the example the example print manager 380 of FIG. 5 and/or the example 3D printer of FIGS. 3-4. The processor platform 700 may be implemented by a server, a desktop computer, a laptop computer, a terminal, a dedicated device, or any other type of computing device.

The processor platform 700 of the illustrated example includes a processor 712. The processor 712 of the illustrated example is hardware. For example, the processor 712 can be implemented by integrated circuits, logic circuits, microprocessors or controllers from any desired family or manufacturer. In the example of FIG. 7, the processor 712 implements the example print manager 380. As such, it implements the example print manager 380, the example encoder manager 510, the example platform positioner 520, the example actuator manager 530 and the example 3D print material applicator manager 540. The processor 712 of the illustrated example includes a local memory 713 (e.g., a cache). The processor 712 of the illustrated example is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 716 may be implemented by flash memory and/or any other desired type of memory device. Access to the main memory (e.g., 714, 716) is controlled by a memory controller.

The processor platform 700 of the illustrated example also includes an interface circuit 720. The interface circuit 720 may be implemented by any type of interface standard, such as an Ethernet interface, a universal serial bus (USB), and/or a PCI express interface.

In the illustrated example, input device(s) 722 are connected to the interface circuit 720. The input device(s) 722 permit(s) a user to enter data and commands into the processor 712. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 724 are also connected to the interface circuit 720 of the illustrated example. The output devices 724 can be implemented, for example, by display devices (e.g., a light emitting diode (LED), an organic light emitting diode (OLED), a liquid crystal display, a cathode ray tube display (CRT), a touchscreen, a tactile output device, a printer, speakers, etc.). In some examples, the interface circuit 720 includes a graphics driver card, a graphics driver chip or a graphics driver processor.

The processor platform 700 of the illustrated example also includes mass storage devices 728 for storing software and/or data. Examples of such mass storage devices 728 include floppy disk drives, hard drive disks, compact disk drives, Blu-ray disk drives, RAID systems, and digital versatile disk (DVD) drives.

The coded instructions 732 of FIG. 7, represented generally in FIG. 6, may be stored in the mass storage device 728, in the volatile memory 714, in the non-volatile memory 716, and/or on a removable tangible computer readable storage medium such as a CD, DVD or solid-state memory device.

In some examples, a tangible computer readable storage medium includes instructions that, when executed, cause the example print manager 380, the example encoder manager 510, the example platform positioner 520, and/or the example 3D print material applicator manager 540 to hold a movable platform 310 at a first position via the platform positioner 520, apply a first layer, via the print medium applicator manager 540, move the movable platform 310, via the plat form positioner 520, in a first direction from the first position to a second position, read a linear encoder strip 340 attached to the moveable platform 310, during movement of the movable platform 310, using an analog encoder reader 350, determine a position of the movable platform 310 using the encoder manager 510 and quadrature modulated signals from the analog encoder reader 350, and stop the movable platform 310 at the second position via the platform positioner 520. In some examples, the platform positioner 520 further includes an actuator manager 530 to control an actuator (e.g., motor 364) to move the movable platform 310 and/or to hold the movable platform 310 at a position specified by the platform positioner 520. In some examples, the instructions, when executed, cause the print manager 380 to hold the movable platform 310 at the second position via the platform positioner 520 and to apply a second layer, via the print medium applicator manager 540.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A 3D printer build unit, comprising:
a movable platform;
a motor to vertically translate the movable platform during an additive manufacturing process executed by the 3D printer to form a product on the movable platform;
a linear encoder strip; and
a linear encoder reader disposed to read the linear encoder strip as the linear encoder strip moves relative to the linear encoder reader.

2. The 3D printer build unit of claim 1, wherein the movable platform includes an upper platform forming a working area for a workpiece, a lower platform, and a plurality of platform travel guides connecting the upper platform and the lower platform.

3. The 3D printer build unit of claim 2, wherein the linear encoder strip is attached to a central portion of the movable platform between the upper platform and the lower platform.

4. The 3D printer build unit of claim 3, further including a control circuit to drive the motor based on an output of the linear encoder reader.

5. The 3D printer build unit of claim 3, wherein the linear encoder strip includes a transparent plastic strip with readable features.

6. The 3D printer build unit of claim 3, wherein the linear encoder strip includes a metal strip with slots.

7. The 3D printer build unit of claim 2, wherein the linear encoder reader includes an analog quadrature encoder.

8. The 3D printer build unit of claim 2, wherein the linear encoder reader includes an analog sensor and an analog to digital converter to interpolate a position of the movable platform.

9. The 3D printer build unit of claim 2, wherein the control circuit includes a print manager including an encoder manager to determine a position of the movable platform from an output of the linear encoder reader.

10. The 3D printer build unit of claim 9, wherein the control circuit includes a platform positioner to move the movable platform to a target position to receive a 3D material from a 3D material applicator.

11. The 3D printer build unit of claim 10, wherein the control circuit includes a print medium applicator manager to cause the 3D material applicator to dispense the 3D material at selected voxels relative to the upper platform of the movable platform or relative to an upper surface of a workpiece on the upper platform of the movable platform.

12. The 3D printer build unit of claim 3, wherein the linear encoder strip is tensioned with resilient elements.

13. A method of controlling a movable platform for a 3D printer, comprising:
moving a linear encoder strip of the moveable platform relative to a linear encoder reader of the moveable platform, one of the linear encoder strip and the linear encoder reader positioned in a fixed position in the moveable platform and another of the linear encoder strip and the linear encoder reader positioned on the movable platform to move with the movable platform;
reading the linear encoder strip using the linear encoder reader; and
determining a vertical position of the movable platform using the reading of the linear encoder strip by the linear encoder reader.

14. The method of controlling the movable platform according to claim 13, further including controlling movement of the movable platform by using the linear encoder strip reading by the linear encoder reader as an input to a closed loop feedback circuit including a platform positioner.

15. The method of controlling the movable platform according to claim 14, further including:
moving the movable platform in a first direction; and
determining a vertical position of the movable platform via the reading of the linear encoder strip during movement of the movable platform in the first direction.
